(19) United States
(12) Patent Application Publication
(10) Pub. No.: US 2023/0186387 A1
(43) Pub. Date: Jun. 15, 2023

(54) INFORMATION PROCESSING DEVICE, INFORMATION PROCESSING METHOD, AND RECORDING MEDIUM

(71) Applicant: Final Aim, Inc., Tokyo (JP)

(72) Inventors: Masafumi ASAKURA, Tokyo (JP); Yasuhide YOKOI, Tokyo (JP)

(21) Appl. No.: 17/924,711

(22) PCT Filed: May 12, 2021
(86) PCT No.: PCT/JP2021/017979

§ 371 Date: Nov. 11, 2022

(30) Foreign Application Priority Data
May 16, 2020 (JP) 2020-086365

(51) Int. Cl. G06Q 40/04; G06Q 20/10

(52) U.S. Cl. CPC G06Q 40/04; G06Q 20/102

(57) ABSTRACT

An information processing device includes: a company storage that stores company information including company value information that specifies the value of a company and stock number information that specifies the number of stocks of the company; a money amount acceptance unit for accepting estimation information including money amount information that specifies the amount of money to be billed, or billing information that includes money amount information; a stock number determination unit for determining the number of stocks equivalent to all or part of the amount of money, and that corresponds to payment, using the company value information and the stock number information; a payment acquisition unit for acquiring payment information including information that specifies the number of stocks, and that is information regarding payment for the amount of money; and a payment output unit for outputtimg the payment information.

### TECHNICAL FIELD

The present invention relates to an information processing device and so on that assist in processing related to payments using stocks.

### BACKGROUND ART

Conventionally, there has been a settlement operation assisting method for assisting in settlement operations for invoices (see Patent Document 1, for example).

Such a settlement operation assisting method is a settlement operation assisting method through which a computer that mediates electronic commerce between companies receives invoice data addressed to a buyer from a supplier's terminal for electronic commerce, stores the invoice data in a storage device, and performs processing to read out the invoice data from the storage device and transmit the invoice data to the buyer's terminal, in response to an acquisition request from the buyer's terminal, the buyer's terminal performs processing to transmit an acquisition request for invoice data addressed to the buyer, to the computer, receive the corresponding invoice data from the computer, add predetermined settlement information or settlement information specified by the buyer from an input device, to the invoice data, to generate one or more pieces of payment schedule data regarding payment to the supplier, and transmit the one or more pieces of payment schedule data to the computer, and the computer performs processing to specify, from among the one or more pieces of payment schedule data received from the buyer's terminal, one or more pieces of payment schedule data that have a predetermined item or an item specified by the buyer terminal in common, add up payment amounts included in the specified payment schedule data and merge the payment schedule data, and store the merged payment schedule data as aggregated payment schedule data in a storage device.

### CITATION LIST

### Patent Document

Patent Document 1: WO2014/041642

### SUMMARY OF INVENTION

### Technical Problem

However, with the prior art, it is impossible to perform appropriate processing for payment with stocks in payment transactions.

### Solution to Problem

An information processing device according to a first aspect of the present invention is an information processing device including: a company storage unit that stores company information that includes company value information that specifies the value of a company and stock number information that specifies the number of stocks of the company; a money amount acceptance unit that accepts estimation information that includes money amount information that specifies the amount of money to be billed, or billing information that includes money amount information; a stock number determination unit that determines the number of stocks that is equivalent to all or part of the amount of money specified by the money amount information accepted by the money amount acceptance unit, and that corresponds to payment, using the company value information and the stock number information, or the stock price information; a payment acquisition unit that acquires payment information that includes information that specifies the number of stocks determined by the stock number determination unit, and that is information regarding payment for the amount of money specified by the money amount information; and a payment output unit that outputs the payment information.

With such a configuration, it is possible to perform appropriate processing for payment with stocks in payment transactions.

An information processing device according to a second aspect of the present invention is the information processing device according to the first aspect, further including a cash acceptance unit that accepts cash specification information that specifies cash to be used for payment, wherein the payment acquisition unit uses information that specifies the number of stocks determined by the number of stocks determination unit and the cash specification information, to acquire the payment information.

With such a configuration, it is possible to perform appropriate processing for payment with both cash and stocks in payment transactions.

An information processing device according to a third aspect of the present invention is the information processing device according to the first or second aspect, wherein the stock number determination unit determines the number of stocks of one type or two types, of the number of actual stocks and the number of potential stocks.

With such a configuration, it is possible to perform appropriate processing for payment with one or more types of stocks, of actual stocks and potential stocks, in payment transactions.

An information processing device according to a fourth aspect of the present invention is the information processing device according to any one of the first to the third aspect, wherein the stock number determination unit determines the number of stocks equivalent to a smaller amount of money than the amount of money specified by the money amount information accepted by the money amount acceptance unit.

With such a configuration, it is possible to perform appropriate processing for payment with stocks by calculating the number of stocks to be used for payment to be smaller than the actual amount of money corresponding to the stocks, in payment transactions.

An information processing device according to a fifth aspect of the present invention is the information processing device according to the fourth aspect, further including: a basis acquisition unit that acquires basis information regarding a basis of the determination when the stock number determination unit determines the number of stocks equivalent to the smaller amount of money; and a basis output unit that outputs the basis information.

With such a configuration, when the number of stocks to be used for payment is calculated to be smaller than the actual amount of money corresponding to the stocks, it is possible to provide assistance in convincing the counterparty.

An information processing device according to a sixth aspect of the present invention is the information processing device according to any one of the first to the fifth aspect, further including a value acceptance unit that accepts company value information or stock price information; a flag acquisition unit that acquires an approval flag that approves acceptance of the company value information or the stock price information; and a company accumulation unit that accumulates company information that includes the company value information or the stock price information, and the approval flag, in the company storage unit.

With such a configuration, it is possible to manage the fact that company value information has been approved.

An information processing device according to a seventh aspect of the present invention is the information processing device according to the sixth aspect, wherein the value acceptance unit further accepts an evaluator identifier, and the flag acquisition unit acquires an approval flag when the evaluator identifier accepted by the value acceptance unit satisfies a predetermined condition.

With such a configuration, it is possible to automatically acquire an approval flag according to an evaluator that has input company value information.

An information processing device according to an eighth aspect of the present invention is the information processing device according to the sixth or the seventh aspect, further including a credit processing unit that, in response to the acquisition of company value information, the stock price information, or the approval flag, performs credit security processing to manage company credit information that includes at least one of the company value information, the stock price information, and the approval flag, in one or more other information processing devices, using a smart contract according to a blockchain technology.

With such a configuration, it is possible to prevent tampering with company value information or an approval flag and realize appropriate management.

An information processing device according to a ninth aspect of the present invention is the information processing device according to any one of the first to the fifth aspect, an evaluator storage unit that stores one or more pieces of evaluator information that each include an evaluator identifier and one or more evaluator attribute values; a value acceptance unit that accepts an evaluator identifier, and company value information or stock price information; a score acquisition unit that acquires guarantee score that indicates a degree of guarantee of the company value information or the stock price information, using one or more evaluator attribute values paired with the evaluator identifier; and a company accumulation unit that accumulates the guarantee score in the company storage unit in association with the company value information or the stock price information.

With such a configuration, it is possible to give an appropriate score based on company value information.

An information processing device according to a tenth aspect of the present invention is the information processing device according to the ninth aspect, wherein the one or more evaluator attribute values include an evaluator score that specifies a rating of an evaluator.

With such a configuration, it is possible to give an appropriate score based on company value information, using the evaluator score.

An information processing device according to an eleventh aspect of the present invention is the information processing device according to the ninth aspect, wherein the evaluator score is a score acquired using one or more pieces of review information that is information regarding a comment given to the evaluator, and is information associated with the evaluator identifier.

With such a configuration, it is possible to acquire appropriate evaluator score.

An information processing device according to a twelfth aspect of the present invention is the information processing device according to any one of the first to the eleventh aspect, wherein the stock number determination unit judges whether or not a predetermined condition is satisfied, and determines the number of stocks corresponding to payment, only when the condition is satisfied, and when the stock number determination unit does not determine the number of stocks, the payment acquisition unit acquires payment information that does not include information that specifies the number of stocks.

With such a configuration, it is possible to assist flexible payment with stocks.

### Advantageous Effects of Invention

With the information processing device according to the present invention, it is possible to perform appropriate processing for payment with stocks in payment transactions.

### BRIEF DESCRIPTION OF DRAWINGS

FIG. 1 is a conceptual diagram for an information system A according to a first embodiment.

FIG. 2 is a block diagram for the information system A according to the same.

FIG. 3 is a flowchart illustrating examples of operations of an information processing device 1 according to the same.

FIG. 4 is a flowchart illustrating an example of stock number determination processing according to the same.

FIG. 5 is a flowchart illustrating an example of stock amount determination processing according to the same.

FIG. 6 is a flowchart illustrating an example of guarantee score acquisition processing according to the same.

FIG. 7 is a flowchart illustrating an example of evaluator score acquisition processing according to the same.

FIG. 8 is a flowchart illustrating an example of approval flag acquisition processing according to the same.

FIG. 9 is a diagram showing evaluator information management table according to the same.

FIG. 10 is a diagram showing company information management table according to the same.

FIG. 11 is a diagram showing basis information management table according to the same.

FIG. 12 is a block diagram showing an information processing device 4 according to the same.

FIG. 13 is an overview diagram for a computer system according to the same.

FIG. 14 is a block diagram for a computer system according to the same.

### DESCRIPTION OF EMBODIMENT

Hereinafter, an embodiment of an information processing device and so on will be described with reference to the drawings. Note that the constituent elements with the same reference numerals perform the same operations in the embodiment, and therefore redundant descriptions thereof may be omitted.

### First Embodiment

The present embodiment describes an information system that includes an information processing device that: accepts estimation information or billing information, which includes money amount information; acquires the number of stocks that corresponds to all or part of the money amount information and is used in payment with stocks, using company value information and stock number information that are stored; and acquires and outputs payment information that includes the acquired number of stocks. Note that the number of stocks either one or both of the number of actual stocks and the number of potential stocks.

In addition, the present embodiment describes an information system that accepts cash specification information that specifies cash to be used for payment, where payment information also includes information regarding the cash specification information.

The present embodiment describes a case in which the number of stocks to be acquired is small compared to the value of the amount of money corresponding thereto.

The present embodiment also describes an information system that includes an information processing device that, when the number of stocks to be acquired is small compared to the value of the amount of money corresponding thereto, outputs information regarding a basis thereof.

The present embodiment also describes an information system that includes an information processing device that acquires and accumulates an approval flag corresponding to company value information. It is preferable that an approval flag is given or not given by an evaluator who has input company value information. In addition, it is preferable that the accuracy of the accumulated company value information and/or approval flag is ensured using blockchain technology.

Furthermore, in the present embodiment, it is preferable that a guarantee score indicating the degree of guarantee for company value information to be accumulated is accumulated in association with company value information. It is also preferable that the guarantee score is acquired using an evaluator score indicating the degree of reliability of the evaluator. It is also preferable that the evaluator score is determined using third-party review information regarding the evaluator.

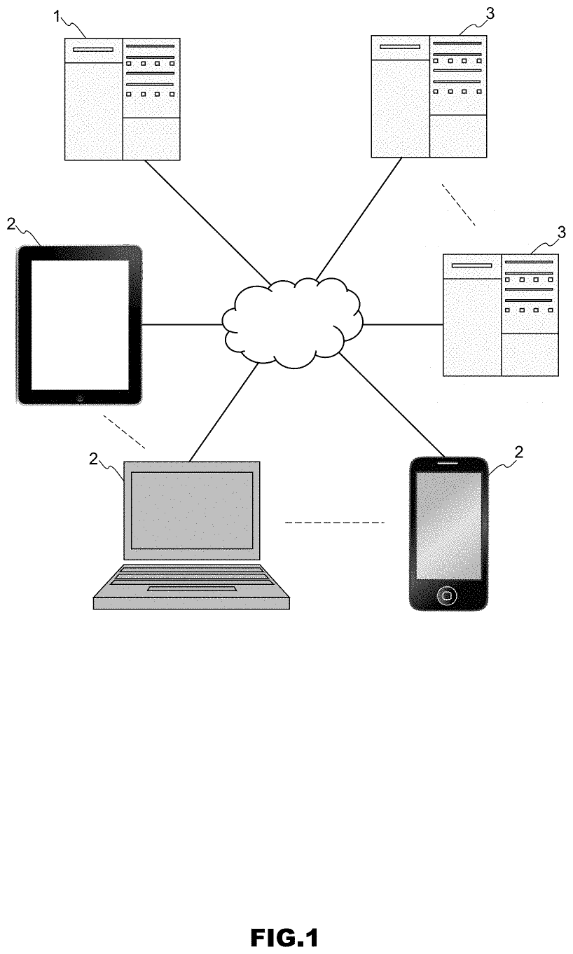

FIG. 1 is a conceptual diagram for an information system A according to the present embodiment. The information system A includes an information processing device 1, one or more terminal devices 2, and one or more server devices 3. The information processing device 1 and the server devices 3 are so-called servers, and are cloud servers and ASP servers, for example. However, the type of the information processing device 1 and the server devices 3 is not limited. Each terminal device 2 is a terminal used by an evaluator. Each terminal device 2 is, for example, a so-called personal computer, a tablet terminal, a smartphone, or the like. However, the type of each terminal device 2 is not limited. Note that each server device 3 is a device for managing review information regarding reviews of an evaluator. Each server device 3 stores review information and evaluator identifiers that identify evaluators that are the subjects of the reviews in association with each other. The server devices 3 are based on a well-known technique, and therefore the detailed description thereof will be omitted.

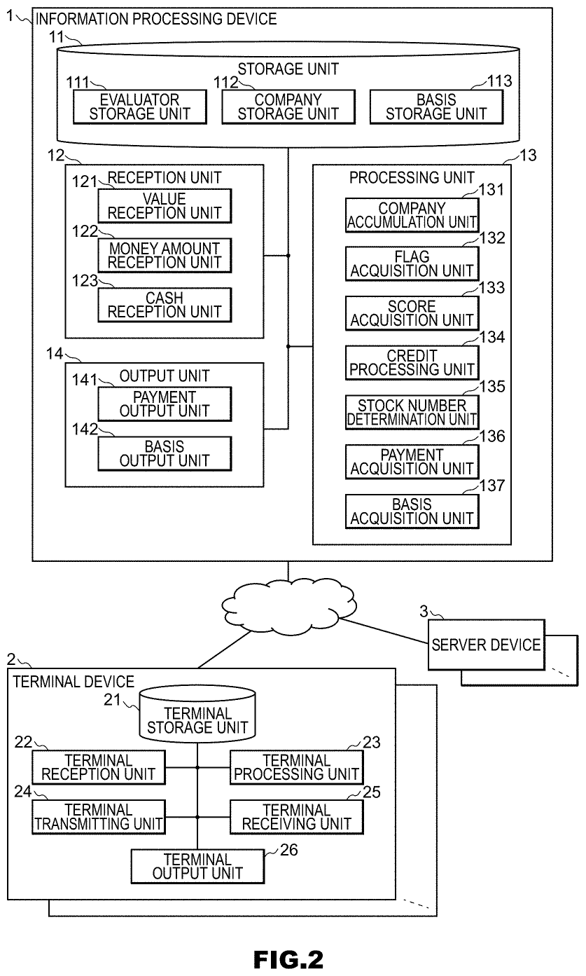

FIG. 2 is a block diagram for the information system A according to the present embodiment. The information processing device 1 included in the information system A includes a storage unit 11, an acceptance unit 12, a processing unit 13, and an output unit 14.

The storage unit 11 includes an evaluator storage unit 111, a company storage unit 112, and a basis storage unit 113. The acceptance unit 12 includes a value acceptance unit 121, a money amount acceptance unit 122, and a cash acceptance unit 123. The processing unit 13 includes a company accumulation unit 131, a flag acquisition unit 132, a score acquisition unit 133, a credit processing unit 134, a stock number determination unit 135, a payment acquisition unit 136, and a basis acquisition unit 137. The output unit 14 includes a payment output unit 141 and a basis output unit 142.

Each terminal device 2 includes a terminal storage unit 21, a terminal acceptance unit 22, a terminal processing unit 23, a terminal transmitting unit 24, a terminal receiving unit 25, and a terminal output unit 26.

The storage unit 11 included in the information processing device 1 stores various kinds of information. Examples of various kinds of information include evaluator information, which will be described later, company information, which will be described later, basis information, which will be described later, review information, which will be described later, and evaluator scores, which will be described later.

The evaluator storage unit 111 stores one or more pieces of evaluator information. Evaluator information is information regarding an evaluator. An evaluator enters company value information or stock price information, or approves company value information. An evaluator is, for example, a person who evaluates a company. An evaluator is, for example, a person who evaluates the value of a company. An evaluator may be an individual or an organization such as a company or a department. Each piece of evaluator information includes an evaluator identifier that identifies the evaluator and one or more evaluator attribute values. The evaluator identifier is, for example, an evaluator ID, a name, a company name, a company ID, a department name, a department ID, an e-mail address, a telephone number, or the like. The evaluator attribute value is, for example, an evaluator type identifier or an evaluator score. The evaluator type identifier is information that identifies the type of the evaluator. The evaluator type identifier is, for example, information indicating that the evaluator is an individual such as an angel or a certified public accountant, information indicating that the evaluator is an angel, information indicating that the evaluator is a certified public accountant, information indicating that the evaluator is a company such as a venture capital or a stock valuation company, information indicating that the evaluator is a venture capital, or information indicating that evaluator is a stock valuation company. The evaluator score is information that specifies the rating of the evaluator. The evaluator score is, for example, information indicating reliability used to evaluate the company. The evaluator score is, for example, a numerical value, but may be information specifying a level such as A, B, or C. The evaluator score is, for example, one of five levels from 1 to 5. The evaluator score is, for example, one of one hundred levels from 1 to 100. The evaluator score is, for example, information acquired by the processing unit 13, or information received by the acceptance unit 12 from a server device 3.

The company storage unit 112 stores one or more pieces of company information. Each piece of company information is information regarding a company. Company information includes, for example, company value information and stock number information. Company information includes, for example, stock price information. Company information may include debt value information that specifies a debt value.

Company value information is information that specifies a value regarding the company. Company value information may also be referred to as information regarding the value of a company. Company value information may be, for example, information that specifies a company value, information that specifies business value, information that specifies a stock value, or the like. Company information typically includes a company identifier that identifies the company. The company identifier is, for example, a company name, an ID, a securities code (registered trademark), a stock code, a new securities code, an ISIN code, or a standard code for a securities company or the like.

Stock number information is information that specifies the number of stocks of a company. The stocks may be both actual stocks and potential stocks or only actual stocks. That is to say, stock number information may be information that specifies the number of actual stocks and the number of potential stocks, information that specifies the total number of actual stocks and potential stocks, information that only specifies the number of actual stocks, or information that only specifies the number of potential stocks. Note that actual stocks refer to issued stocks that provide the shareholder's rights, such as issued common stocks and preferred stocks. Potential stocks are those that are not actually stocks, but refer to the rights to acquire stocks or those that can be converted into stocks, e.g., stock acquisition rights and convertible bonds.

Stock price information is information that specifies the stock price. Note that stock price information is, for example, a value calculated by “stock price information=(company value information−debt value information)/stock number information”. Stock price information is information that specifies the stock price per stock unit (e.g., per share).

The basis storage unit 113 stores one or more pieces of basis information. Basis information is information regarding the basis for the determination when the stock number determination unit 135 determines the number of stocks equivalent to an amount of money smaller than a target amount.

Basis information is associated with company information, for example. For example, the basis for determining the number of stocks is different for each company.

The acceptance unit 12 accepts various kinds of instructions, information, and so on. Examples of various instructions, information, and so on include company value information, an evaluator identifier, money amount information, which will be described later, estimation information, which will be described later, billing information, which will be described later, cash specification information, which will be described later, a payment instruction, review information, an evaluator score, which will be described later, an approval instruction, and an approval flag.

Note that a payment instruction is an instruction regarding payment. A payment instruction is an instruction to perform processing related to payment. Processing related to payment is, for example, settlement processing, or processing that is performed to accumulate information regarding payment. Settlement processing is processing related to settlement, such as making a settlement or transmitting information necessary for settlement to a settlement server, and includes processing that is performed to assist settlement. A payment instruction includes, for example, billing information, estimation information, or money amount information. A payment instruction includes, for example, cash specification information.

Review information is information regarding reviews of an evaluator. Review information is information regarding reviews of one evaluator input by other evaluators. Review information typically is a string. Review information typically is information received from a server device 3.

An approval instruction is an instruction to approve company value information regarding one company that is to be approved. Note that an approval instruction typically includes a company identifier of the company to be approved and the evaluator identifier of the evaluator that gives approval.

An approval flag is a flag indicating approval to company value information regarding one company that is to be approved. For example, if the approval flag corresponding to company value information regarding one company is “1”, it indicates “approved”, and if the approval flag corresponding to company value information is “0”, it indicates “not approved”.

Here, “acceptance” means, for example, reception from an external device such as a terminal device 2 or a server device 3. Here, “acceptance” may be regarded as a concept that includes acceptance of information input from an input device such as a keyboard, a mouse, or a touch panel, and acceptance of information read out from a recording medium such as an optical disk, a magnetic disk, or a semiconductor memory.

For example, the reception unit 12 receives one or more pieces of review information for each of one or more evaluator identifiers, from a server device 3. For example, the reception unit 12 receives an evaluator score for each of one or more evaluator identifiers, from a server device 3.

The value acceptance unit 121 accepts, for example, company value information. The value acceptance unit 121 accepts, for example, stock price information. The value acceptance unit 121 accepts, for example, an evaluator identifier as well. The value acceptance unit 121 accepts, for example, an evaluator identifier and company value information. The value acceptance unit 121 accepts, for example, an evaluator identifier and stock price information. Note that an evaluator identifier is the identifier of the evaluator that has input company value information.

The value acceptance unit 121 typically accepts company value information or stock price information in association with a company identifier. This company identifier is the identifier of a company that has a value specified by company value information or the identifier of a company that has a stock price specified by stock price information.

Acceptance by the value acceptance unit 121 typically is reception from a terminal device 2.

The money amount acceptance unit 122 accepts money amount information. Money amount information is information that specifies the amount of money. The money amount acceptance unit 122 accepts, for example, estimation information or billing information. The money amount acceptance unit 122 typically accepts money amount information in association with a company identifier. The money amount acceptance unit 122 typically accepts estimation information or billing information in association with a company identifier. Acceptance in association with a company identifier may be acceptance of a company identifier as well, or acceptance of information corresponding to the company identifier as well. This company identifier is the identifier of the company that is to pay the amount of money corresponding to an estimation or a bill.

Estimation information is information regarding a quotation or estimation. Estimation information includes money amount information that specifies an amount of money to be billed. The amount of money to be billed is, for example, an estimated amount. Estimation information may only include money amount information. Estimation information includes, for example, a quotation identifier, a company identifier, and a counterparty identifier. A quotation identifier is information that identifies a quotation. A company identifier is the identifier of a paying company. The counterparty identifier is information that identifies the company or the like that prepared the quotation.

Billing information is information regarding an invoice or billing. Billing information includes money amount information that specifies the amount of money to be billed. Billing information may only include money amount information. Billing information includes, for example, an invoice identifier, a company identifier, a counterparty identifier, and bank account information. An invoice identifier is information that identifies an invoice. A company identifier is the identifier of a paying company. The counterparty identifier is information that identifies the company or the like that prepared the invoice.

The money amount acceptance unit 122 may accept a payment instruction that includes estimation information or billing information or money amount information. A payment instruction is an instruction to pay an amount of money. A payment instruction typically includes a company identifier.

The cash reception unit 123 accepts cash specification information. The cash reception unit 123 typically accepts cash specification information in association with estimation information, or billing information, or a payment instruction. Cash specification information is information that specifies cash that is used for payment. Cash specification information may be an absolute value of the amount of money, or information indicating the ratio of stocks to cash or the like.

The processing unit 13 performs various kinds of processing. Examples of various kinds of processing include processing that is performed by the company accumulation unit 131, the flag acquisition unit 132, the score acquisition unit 133, the credit processing unit 134, the stock number determination unit 135, the payment acquisition unit 136, and the basis acquisition unit 137.

For example, the processing unit 13 acquires an evaluator score, using information received from a server device 3. For example, the processing unit 13 acquires an evaluator score for each evaluator through processing that is the same as processing that is performed by a server processing unit, which will be described later, using review information or scores input by one or more people that have posted review information.

For example, the processing unit 13 performs processing related to payment, upon accepting a payment instruction. The processing unit 13 may perform settlement processing upon accepting a payment instruction.

For example, the company accumulation unit 131 accumulates company information that includes company value information and an approval flag, in the company storage unit 112. For example, the company accumulation unit 131 accumulates company information that includes stock price information and an approval flag, in the company storage unit 112. The company accumulation unit 131 does not need to accumulate company value information or stock price information and an approval flag at the same time. For example, after accumulating company value information or stock price information, the company accumulation unit 131 may accumulate an approval flag that is paired with the company value information or the stock price information.

Note that the company value information to be accumulated typically is information received by the value acceptance unit 121. The approval flag to be accumulated is information received by the acceptance unit 12 or information acquired by the flag acquisition unit 132, which will be described later.

The company accumulation unit 131 accumulates a guarantee score in the company storage unit 112 in association with company value information. The guarantee score typically is a guarantee score acquired by the score acquisition unit 133.

The flag acquisition unit 132 acquires an approval flag that approves acceptance of company value information. For example, the flag acquisition unit 132 acquires an approval flag received by the acceptance unit 12. For example, the flag acquisition unit 132 acquires an approval flag when the evaluator identifier paired with the company value information accepted by the value acceptance unit 121 satisfies a predetermined condition. The approval flag indicates “1”, for example, and typically is predetermined information, and is stored in the storage unit 11, for example.

The predetermined condition is, for example, the evaluator identifier is an evaluator identifier that is under control, the evaluator identifier is an evaluator identifier paired with an evaluator type identifier that is under control, or the evaluator score paired with the evaluator identifier is no less than or greater than a threshold value.

The flag acquisition unit 132 may acquire an approval flag for company value information corresponding to a predetermined evaluator identifier. The predetermined evaluator identifier is information that identifies an evaluator that is reliable. The predetermined evaluator identifier is, for example, provided as one or more predetermined evaluator identifiers stored in the storage unit 11. The predetermined evaluator identifier is, for example, provided as evaluator identifiers paired with one or more predetermined evaluator type identifiers.

The approval flag may be received by the acceptance unit 12 from a terminal device 2 together with company value information.

The evaluator identifier here is information that identifies a person who determines company value information. A person identified by an evaluator identifier is, for example, an individual such as an angel, a corporation such as a venture capital, a stock valuation company, a certified public accountant, or the like.

The time at which the flag acquisition unit 132 acquires the approval flag is not limited. The flag acquisition unit 132 may acquire the approval flag upon accepting company value information, or acquire the approval flag in response to a predetermined trigger after accepting corporate value information. The predetermined trigger is arrival of a predetermined time, acceptance of an evaluator's instruction, or the like.

For example, using one or more evaluator attribute values paired with the evaluator identifier corresponding to company value information, the score acquisition unit 133 acquires the guarantee score of the company value information. For example, using one or more evaluator attribute values paired with the evaluator identifier corresponding to stock price information, the score acquisition unit 133 acquires the guarantee score of the company value information. The guarantee score is information that indicates the degree of guarantee. The guaranteed score may also be referred to as information that indicates the reliability of company value information or stock price information. For example, the score acquisition unit 133 acquires a higher guarantee score for a higher evaluator score. Also, regarding the evaluator type identifier, the score acquisition unit 133 acquires a higher guarantee score in the following order, for example: “an individual such as an angel<a certified public accountant<a corporation such as a venture capital<a stock valuation company”.

For example, the score acquisition unit 133 may acquire a guarantee score, using one or more evaluator attribute values paired with an evaluator identifier corresponding to company value information or stock price information, and one or more company attribute values paired with company value information.

For example, the score acquisition unit 133 may acquire a guarantee score according to a machine learning algorithm, using one or more parameters. For example, the score acquisition unit 133 may acquire a guarantee score by substituting one or more parameters into an arithmetic expression for calculating the guaranteed score. For example, the score acquisition unit 133 may acquire, from a correspondence table, a guarantee score paired with a vector that is closest to a vector that has one or more parameters as elements. In such a case, the correspondence table has two or more pieces of correspondence information each being a set consisting of a vector that has one or more parameters as elements, and a guarantee score. Note that each of the one or more parameters is an evaluator attribute value, for example. Alternatively, each of the one or more parameters is an evaluator attribute value or a company attribute value, for example.

When using a machine learning algorithm, the score acquisition unit 133 performs learning processing according to a machine learning algorithm, using, for example, two or more teacher data sets each including one or more parameters and a guarantee score, to form a leaner. Thereafter, for example, using the learner and one or more parameters that are to be evaluated, the score acquisition unit 133 performs prediction processing according to a machine learning algorithm, to acquire a guarantee score. The machine learning algorithm is, for example, deep learning, SVR, random forest, decision tree, or the like, and is not limited. Performing learning processing using a machine learning algorithm is giving two or more pieces of teacher data to a function that realizes a machine learning algorithm (for example, a function of TinySVM, fastText, or TensorFlow) and executing learning processing. Performing prediction processing using a machine learning algorithm is giving a learner and one or more parameters for an evaluation target to a function that realizes a machine learning algorithm (for example, a function of TinySVM, fastText, or TensorFlow) and executing prediction processing. Note that the function may be referred to as a method, a module, or the like.

Alternatively, the score acquisition unit 133 may give one or more parameters to an arithmetic expression stored in the storage unit 11 and execute the arithmetic expression to acquire a guarantee score. Note that the arithmetic expression is an expression that is used to calculate a guarantee score.

For example, the score acquisition unit 133 calculates a guarantee score using an increasing function that employs, as a parameter, an evaluator score that is paired with an evaluator identifier corresponding to company value information or stock price information.

For example, the score acquisition unit 133 acquires, as a guarantee score, an evaluator score paired with an evaluator identifier corresponding to company value information or stock price information.

For example, the score acquisition unit 133 calculates a guarantee score using an increasing function that employs, as a parameter, a rank corresponding to an evaluator type identifier that is paired with an evaluator identifier corresponding to company value information or stock price information. In such a case, two or more sets each consisting of an evaluator type identifier and a rank are stored in the storage unit 11.

For example, in response to the acquisition of company value information and an approval flag, the credit processing unit 134 performs credit security processing to manage company credit information that includes at least either the company value information or the approval flag in one or more other information processing devices, using a smart contract according to a blockchain technology. For example, in response to the acquisition of stock price information and an approval flag, the credit processing unit 134 performs credit security processing to manage company credit information that includes at least either the stock price information or the approval flag in one or more other information processing devices, using a smart contract according to a blockchain technology.

Credit security processing is, for example, to transmit company credit information to one or more other information processing devices. Credit security processing is, for example, to encrypt and transmit company credit information to one or more other information processing devices. Note that the one or more other information processing devices are predetermined devices. Through credit security processing, company credit information is managed by a plurality of devices, using a block chain mechanism.

The stock number determination unit 135 determines the number of stocks that is equivalent to all or part of the amount of money specified by the money amount information accepted by the money amount acceptance unit 122, and that corresponds to the payment, using company value information and stock number information, for example. The stock number determination unit 135 determines the number of stocks that is equivalent to all or part of the amount of money specified by the money amount information accepted by the money amount acceptance unit 122, and that corresponds to the payment, using stock price information, for example.

The stock number determination unit 135 may judge whether or not a first condition is satisfied, and determine the number of stocks corresponding to the payment only when the first condition is satisfied. Note that the first condition is a condition for using stocks for payment. The first condition is, for example, an amount condition that is a condition related to money amount information, a company condition that is a condition related to company information, or a combination of the amount condition and the company condition. The money amount condition is that money amount information is no less than or greater than a threshold value. The company condition is, for example, that the approval flag is associated with the company identifier of the subject company, or the guarantee score associated with the company identifier is no less than or greater than a threshold value.

If a portion of the amount of money specified by the money amount information accepted by the money amount acceptance unit 122 is to be paid using stocks, the number of stocks to be used may be determined in advance or vary dynamically.

Examples of cases in which the number of stocks is determined in advance include a case in which the ratio of payment in stocks to payment in cash is determined in advance, and a case in which the amount of money paid using stocks or by cash is determined in advance. In the case in which the number of stocks vary dynamically, the stock number determination unit 135 may vary the number based on the number of stocks of the company. In the case where it varies based on the number of stocks, for example, the stock number determination unit 135 determines a larger number of stocks for a larger value indicated by stock number information regarding the company storage unit 112.

For example, the stock number determination unit 135 acquires the price of one stock and calculates the number of stocks corresponding to the payment through “money amount information/stock price”. Note that the stock number determination unit 135 executes the arithmetic formula “stock price=(company value information−debt value information)/stock number information” to calculate the price of one stock. For example, the stock number determination unit 135 reads out stock price information that specifies the price of one stock, from the company storage unit 112.

For example, using the acquired price of one stock, the stock number determination unit 135 calculates the number of stocks corresponding to the payment through “money amount information×ratio/stock price”. The ratio is determined in advance, and the number of stocks corresponding to the payment is the number of stocks equivalent to the amount of money corresponding to the ratio in the money amount information. Note that the stock price may be calculated in advance, and the stock price may be stored in the company storage unit 112 in advance as one of the attribute values included in company information.

The stock number determination unit 135 determines the number of stocks of one type or two types, of the number of actual stocks and the number of potential stocks. When the stock number determination unit 135 determines the number of stocks for each of two types, the ratio between the number of actual stocks and the number of potential stocks may be predetermined or may vary dynamically. In the case where the ratio varies dynamically, for example, the ratio is determined dynamically based on the status of the current actual stocks and issuance or allocation of the potential stocks. In addition, the stock number determination unit 135 may dynamically determine the number of stocks based on the status of the potential stocks (the number of remaining option pools, the number of issued and unallocated stock acquisition rights, or the like). For example, the stock number determination unit 135 determines the number of actual stocks and the number of potential stocks so that the ratio will be the same as the current ratio between the issuance numbers of actual stocks and potential stocks. For example, the stock number determination unit 135 sets the number of actual stocks to a number no greater than a predetermined percentage of the current number of actual stocks, and upon judging that the current number of actual stocks is not enough, determines the number of potential stocks corresponding to the shortfall in value.

For example, the stock number determination unit 135 determines the number of stocks equivalent to an amount of money smaller than the amount of money specified by the money amount information accepted by the money amount acceptance unit 122. Such determination is determination method in consideration of development of the company's business in the future. For example, the stock number determination unit 135 determines a smaller number of stocks corresponding to the prospect of an increase in the value of the company in the future, based on a business plan or the like. For example, the stock number determination unit 135 acquires a score of a business plane of the company of interest, from the storage unit 11, acquires reduction information paired with the score, from a correspondence table, acquires a smaller money amount, using the amount of money specified by the money amount information accepted by the money amount acceptance unit 122 and the reduction information, and determines the number of stocks that is equivalent to the smaller money amount. Note that the correspondence table is a table that includes two or more pieces of correspondence information that each is a set consisting of a business plan score and reduction information that indicates a reduction ratio or an amount to be reduced. For example, the stock number determination unit 135 substitutes a score of a business plane of the company of interest, into an arithmetic expression, executes the arithmetic expression to acquire reduction information, acquires a smaller money amount, using the amount of money specified by the money amount information accepted by the money amount acceptance unit 122 and the reduction information, and determines the number of stocks that is equivalent to the smaller money amount. Note that the above arithmetic expression is an arithmetic expression that employs a business plan score as a parameter, and is used to calculate reduction information that indicates the percentage or the amount of money to be reduced. It is assumed that the correspondence table or the arithmetic expression is stored in the storage unit 11.

For example, the stock number determination unit 135 determines the number of stocks equivalent to an amount of money obtained by reducing a predetermined amount of money from the amount of money specified by the money amount information accepted by the money amount acceptance unit 122. That is to say, the stock number determination unit 135 calculates the number of stocks corresponding to the payment through “the number of stocks=(money amount information−predetermined amount of money)/stock price”. Note that the predetermined amount of money typically is the amount of payment in cash.

For example, the stock number determination unit 135 determines the number of stocks equivalent to an amount of money corresponding to a predetermined proportion (for example, 0.9) of the amount of money specified by the money amount information accepted by the money amount acceptance unit 122. That is to say, for example, when a predetermined proportion (for example, X %) of the payment amount is to be paid in cash, the stock number determination unit 135 calculates the number of stocks corresponding to the payment through “the number of stocks=(money amount information×(100−X)/100)/stock price”, for example.

Note that, when acquiring the number of stocks using company value information or stock price information, the stock number determination unit 135 may use the company value information or stock price information determined in the past without change, or use the company value information or the stock price information in view of a fluctuation factor. The fluctuation factor is, for example, a factor of fluctuations in company value information or stock price information caused by an increase or a decrease in the company value of the individual company or an increase or a decrease in the average stock price thereof. For example, when determining the number of stocks after a certain period of time has elapsed from when the company value was approved, the stock number determination unit 135 takes into consideration the fluctuation factor that occurred during the period by multiplying the acquired company value information or stock price information by a certain coefficient, and acquires the number of stocks through the above-described processing, using the company value information or the stock price information with the fluctuation factor being taken into consideration. For example, the stock number determination unit 135 may acquire fluctuation factor information that is information specifying the fluctuation factor, from the storage unit 11, multiply the acquired company value information or stock price information by the fluctuation factor information to acquire predicted current company value information or stock price information, and acquire the number of stocks, using the predicted company value information or stock price information. Note that the fluctuation factor information is, for example, the rate of change of the Nikkei Stock Average during the period corresponding thereto, or the average rate of change of the stock price of the industry of the company during the period.

The payment acquisition unit 136 acquires payment information that includes information that specifies the number of stocks determined by the stock number determination unit 135, and that is information regarding payment for the amount of money specified by money amount information. For example, only stocks are used for payment, payment information is stock number information, for example. For example, only stocks are used for payment, payment information is a set consisting of a stock type identifier and stock number information, for example. For example, only stocks are used for payment, payment information includes two sets each consisting of a stock type identifier and stock number information, for example. Note that the stock type identifier is information that specifies actual stocks or potential stocks.

For example, the payment acquisition unit 136 acquires payment information, using information that specifies the number of stocks determined by the stock number determination unit 135 and cash specification information. That is to say, in such a case, when cash specification information is cash information that indicates cash, payment information includes stock number information and cash information. When cash specification information is information that indicates the ratio of stocks to cash, payment information includes stock number information and cash information calculated using cash specification information, for example. In such a case, for example, “cash information=the money amount information accepted by the money amount acceptance unit 122×the ratio indicated by cash specification information” is satisfied.

For example, when the stock number determination unit 135 does not determine the number of stocks, the payment acquisition unit 136 acquires payment information that does not include information that specifies the number of stocks. In such a case, payment information typically is cash information.

In a case where the stock number determination unit 135 determines a number of stocks equivalent to a smaller amount of money, the basis acquisition unit 137 acquires basis information regarding the basis of the determination. For example, the basis acquisition unit 137 acquires basis information that is paired with the company corresponding to the money amount information accepted by the money amount acceptance unit 122, from the basis storage unit 113.

The output unit 14 outputs various kinds of information. Examples of various kinds of information include payment information and basis information. Here, “output” typically means transmission to a terminal device 2 or the like, but may be regarded as a concept that includes displaying on a display device, projection with a projector, printing with a printer, sound output, accumulation on a recording medium, delivery of processing results to another processing device or another program, and so on.

The payment output unit 141 outputs the payment information acquired by the payment acquisition unit 136. Here, “output” typically means transmission to a terminal device 2 or the like.

The basis output unit 142 outputs the basis information acquired by the basis acquisition unit 137. Here, “output” typically means transmission to a terminal device 2 or the like.

The terminal storage unit 21 included in the terminal device 2 stores various kinds of information. Examples of various kinds of information include a company identifier, estimation information, billing information, and money amount information.

The terminal acceptance unit 22 accepts various kinds of instructions, information, and so on. Examples of various kinds of instructions and information include estimation information, billing information, money amount information, a payment instruction, company value information, an approval instruction, and an approval flag. A payment instruction is an instruction to output payment information. A payment instruction includes, for example, estimation information, billing information or money amount information. A payment instruction includes, for example, the company identifier of the paying company.

Any input means, such as a touch panel, a keyboard, a mouse, a menu screen, or the like, may be employed to input various kinds of information and instructions.

The terminal processing unit 23 performs various kinds of processing. Various kinds of processing are performed to convert the various kinds of instructions and information accepted by the terminal acceptance unit 22 into various kinds of instructions and information in a data structure that is to be transmitted, for example. Various kinds of processing are performed to convert the information received by the terminal receiving unit 25 into information in a data structure that is to be output, for example.

The terminal transmitting unit 24 transmits various kinds of instructions and information to the information processing device 1. Examples of various kinds of instructions and information include estimation information, billing information, money amount information, a payment instruction, company value information, an approval instruction, and an approval flag. The terminal transmitting unit 24 transmits the information formed by the terminal processing unit 23 to the information processing device 1.

The terminal receiving unit 25 receives various kinds of information. Examples of various kinds of information include payment information. Examples of various kinds of information include the result of the payment processing performed using payment information.

The terminal output unit 26 outputs various kinds of information. Examples of various kinds of information include payment information and the result of payment processing performed using payment information. The terminal output unit 26 outputs the information formed by the terminal processing unit 23.

A server storage unit (not shown) that is included in each server device 3 stores one or more pieces of review information respectively in association with one or more evaluator identifiers. The server storage unit may store count information that indicates the number of pieces of review information respectively in association with one or more evaluator identifiers. The server storage unit may store an evaluator score in association with each of one or more evaluator identifiers. Note that the evaluator score is information that specifies the rating of the evaluator.

A server processing unit (not shown) included in the server device 3 may acquires an evaluator score using the review information in the server storage unit. For example, for each evaluator, the server processing unit acquires a higher score for a larger number of reviews corresponding to the evaluator identifier thereof. For example, the server processing unit acquires a representative value (for example, a mean value or a median value) of the scores input by one or more people who have posted review information, as an evaluator score.

For example, the server processing unit performs may perform linguistic processing on each of the one or more pieces of review information to determine whether each piece of information is positive or negative, and use the results of the determination to acquire an evaluator score. The server processing unit typically acquires a higher evaluator score for a larger number of pieces of positive review information, and acquires a lower evaluator score for a larger number of pieces of negative review information. The server processing unit calculates an evaluator score using an increasing function with the number of pieces of positive review information as a parameter and a decreasing function with the number of pieces of negative review information as a parameter.

For example, the server processing unit may perform linguistic processing on each of one or more pieces of review information to calculate the degree of positivity or the degree of negativity of each piece of review information, and acquire an evaluator score using the degree of positivity or the degree of negativity. The degree of positivity and the degree of negativity is, for example, a five-grade evaluation from 1 to 5 or a natural number from 1 to 100.

For example, the server processing unit calculates an evaluator score by adding the degree of positivity (a positive value) or the degree of negativity (a negative value) of each piece of review information. Alternatively, for example, the server processing unit may reference a correspondence table that includes five pieces of correspondence information indicating the correspondence between five-grade numerical values from 1 to 5 and pieces of information respectively indicating the ranges of the evaluator score, and acquire a numerical value (one of the numerical values 1 to 5) that is paired with the calculated evaluator score, as the ultimate evaluator score.

A server receiving unit (not shown) that is included in the server device 3 receives an instruction from the information processing device 1, and upon the receipt of the instruction, the server transmitting unit (not shown) transmits the review information and/or the evaluator score in the server storage unit to the information processing device 1. Note that, for example, when an instruction includes an evaluator identifier, the server transmitting unit transmits one or more pieces of review information and/or evaluator scores that are paired with the evaluator identifier included in the instruction, to the information processing device 1.

It is preferable that the storage unit 11, the evaluator storage unit 111, the company storage unit 112, the basis storage unit 113, and the terminal storage unit 21 are realized using a non-volatile recording medium, but they may be realized using a volatile recording medium.

There is no limitation on the process in which information is stored in the storage unit 11 and so on. For example, information may be stored in the storage unit 11 or the like via a recording medium, or information transmitted via a communication line or the like may be stored in the storage unit 11 or the like, or information input via an input device may be stored in the storage unit 11 or the like.

The acceptance unit 12, the value acceptance unit 121, the money amount acceptance unit 122, the cash acceptance unit 123, and the terminal receiving unit 25 typically are realized using a wireless or wired communication means, but may be realized using a broadcast receiving means.

The processing unit 13, the company accumulation unit 131, the flag acquisition unit 132, the score acquisition unit 133, the credit processing unit 134, the stock number determination unit 135, the payment acquisition unit 136, the basis acquisition unit 137, and the terminal processing unit 23 can typically be realized using a processor, a memory, and so on. The processing procedures performed by the processing unit 13 and so on typically are realized using software, and the software is recorded on a recording medium such as a ROM. However, such processing procedures may be realized using hardware (a dedicated circuit). The processor is, for example, a CPU, an MPU, a GPU, or the like, and the type thereof is not limited.

The output unit 14, the payment output unit 141, the basis output unit 142, and the terminal transmitting unit 24 typically are realized using a wireless or wired communication means, but may be realized using a broadcast receiving means.

The terminal acceptance unit 22 can be realized using a device driver for the input means such as a touch panel or a keyboard, or control software or the like for controlling the menu screen.

The terminal output unit 26 may be regarded as including or not including an output device such as a display or a speaker. The terminal output unit 26 can be realized using the driver software of the output device, the driver software of the output device and the output device, or the like.

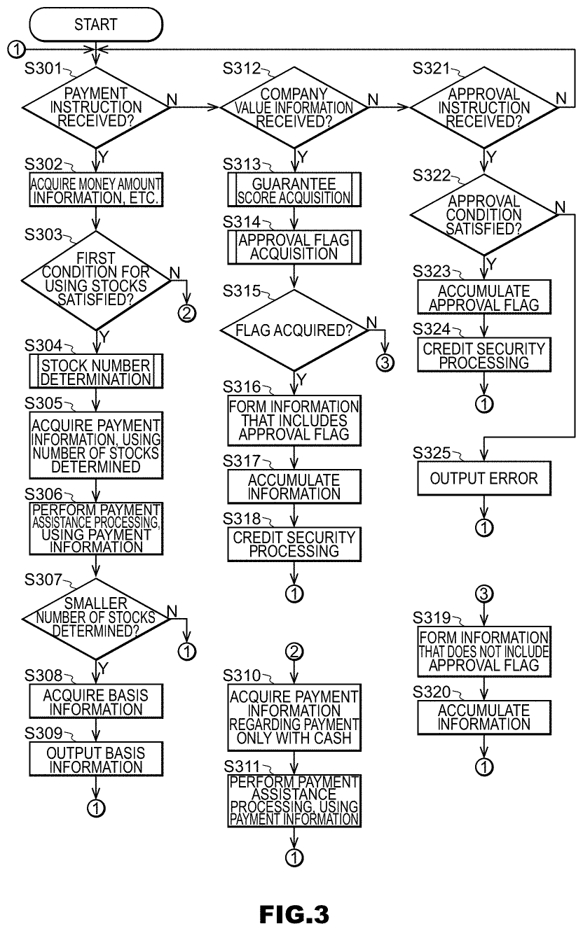

Next, operations of the information system A will be described. First, examples of operations of the information processing device 1 will be described with reference to the flowchart shown in FIG. 3.

(Step S301) The acceptance unit 12 judges whether or not a payment instruction has been received from a terminal device 2. If a payment instruction has been received, processing proceeds to step S302, and if a payment instruction has not been received, processing proceeds to step S312.

(Step S302) The stock number determination unit 135 acquires money amount information and so on from the payment instruction received in step S301. Examples of money amount information and so on include money amount information, cash specification information, and the company of the paying company.

(Step S303) The stock number determination unit 135 judges whether or not the first condition, which is a condition for using stocks for payment, is satisfied. If the first condition is satisfied, processing proceeds to step S304, and if the first condition is not satisfied, processing proceeds to step S310. Note that, if the first condition consists of a money amount condition (for example, “money amount information>=100,000 yen”) and a company condition (for example, “guarantee score>=80” AND “approval flag”=ON”, the stock number determination unit 135 judges whether or not the money amount information acquired in step S302 satisfies the money amount condition, and acquires the guarantee score paired with the received identifier and the approval flag from the company storage unit 112, judges whether or not the guarantee score and the approval flag satisfies the company condition, and judges that the first condition is satisfied if both the money amount condition and the company condition are satisfied.

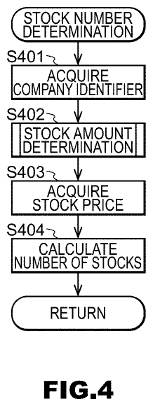

(Step S304) The stock number determination unit 135 performs stock number determination processing. An example of stock number determination processing will be described with reference to the flowchart shown in FIG. 4.

(Step S305) The payment acquisition unit 136 forms payment information that includes stock number information that specifies the number of stocks determined in step S304, and cash information that is acquired using the cash specification information included in the payment instruction received in step S301. Note that when cash specification information is information that specifies cash, cash information is cash specification information. When cash specification information is information that specifies the ratio of cash, cash information is “money amount information×cash specification information”. Payment information has, for example, the following structure: “<type identifier> actual stocks <stock number information> X stocks, <type identifier> cash <amount of money> Y yen”. The payment acquisition unit 136 may divide the payment in stocks between actual stocks and potential stocks. In such a case, payment information has, for example, the following structure: “<type identifier> actual stocks <stock number information> X₁ stocks, <type identifier> potential stocks <stock number information> X₂ stocks, <type identifier> cash <amount of money> Y yen”.

(Step S306) The payment output unit 141 outputs the payment information acquired in step S305. Payment assistance processing is performed through such output. Payment assistance processing is processing for payment performed using payment information, examples of which include transmission of payment information to a settlement server (not shown), transmission of payment information to a terminal device 2, accumulation of payment information in the storage unit 11, delivery of payment information to the processing unit 13, and so on. Payment assistance processing is performed by the payment output unit 141, for example.

(Step S307) It is judged whether or not the stock number determination unit 135, in step S304, determines a number of stocks corresponding to a smaller amount of money than the actual amount of money to be paid using stocks. If the number of stocks corresponds to a smaller amount of money, processing proceeds to step S308, and if the number of stocks corresponds to the same amount of money, processing returns to step S301.

(Step S308) The basis acquisition unit 137 acquires basis information that is paired with the company identifier included in the payment instruction, from the basis storage unit 113.

(Step S309) The basis output unit 142 transmits the basis information acquired in step S308 to the terminal device 2. Processing returns to step S301.

(Step S310) Payment acquisition unit 136 forms payment information indicating that the money amount information acquired in step S302 indicates cash. The payment information to be formed has, for example, the following structure: “<type identifier> cash <amount of money> Z yen”.

(Step S311) The payment output unit 141 outputs the payment information acquired in step S310. Payment assistance processing is performed through such output. Processing returns to step S301.

Payment assistance processing is processing for payment performed using payment information, examples of which include transmission of payment information to a settlement server (not shown), transmission of payment information to a terminal device 2, accumulation of payment information in the storage unit 11, delivery of payment information to the processing unit 13, and so on.

(Step S312) The value acceptance unit 121 judges whether or not company value information and so on has been received from the terminal device 2. If company value information and so on has been received, processing proceeds to step S313, and if company value information and so on has not been received, processing proceeds to step S321. Examples of company value information and so on include company value information, an evaluator identifier, and a company identifier. An evaluator identifier is the identifier of the evaluator that has input company value information. A company identifier is the identifier of the company that is to be subjected to valuation.

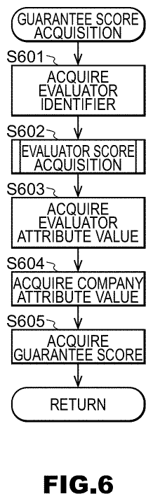

(Step S313) The score acquisition unit 133 performs guarantee score acquisition processing. An example of guarantee score acquisition processing will be described with reference to the flowchart shown in FIG. 6.

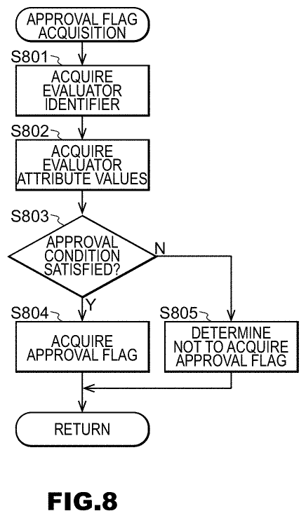

(Step S314) The flag acquisition unit 132 performs approval flag acquisition processing. An example of approval flag acquisition processing will be described with reference to the flowchart shown in FIG. 8.

(Step S315) The company accumulation unit 131 judges whether or not an approval flag has been acquired in step S314. If an approval flag has been acquired, processing proceeds to step S316, and if an approval flag has not been acquired, processing proceeds to step S319.

(Step S316) The company accumulation unit 131 forms information that includes the company value information received in step S312, the evaluator identifier, the guarantee score, and the approval flag.

(Step S317) The company accumulation unit 131 accumulates the information formed in step S316, in association with the company identifier received in step S312.

(Step S318) The credit processing unit 134 performs credit security processing. Processing returns to step S301. Note that credit security processing is processing that is performed using a blockchain technology, for example. Credit security processing is performed to, for example, encrypt company credit information that includes the company value information accumulated by the company accumulation unit 131, the approval flag, and so on, and transmit the encrypted company credit information to one or more other information processing devices.

(Step S319) The company accumulation unit 131 forms information that includes the company value information received in step S312, the evaluator identifier, and the guarantee score. Note that the information formed here does not include an approval flag.

(Step S320) The company accumulation unit 131 accumulates the information formed in step S319, in association with the company identifier received in step S312. Processing returns to step S301.

(Step S321) The acceptance unit 12 judges whether or not an approval instruction has been received from the terminal device 2. If an approval instruction has been received, processing proceeds to step S322, and if an approval instruction has not been received, processing returns to step S301. Note that the approval instruction may be the same information as the approval flag.

(Step S322) The processing unit 13 judges whether or not the approval instruction received in step S321 satisfies an arrival condition. If the approval condition is satisfied, processing proceeds to step S323, and if the approval condition is not satisfied, processing proceeds to step S325. Note that the processing unit 13 uses one or more evaluator attribute values that are paired with the evaluator identifier included in the approval instruction, to judge whether or not the approval condition is satisfied. For example, the processing unit 13 judges that the approval condition is satisfied if the evaluator score that is paired with the evaluator identifier included in the approval instruction is no less than or greater than a threshold value.

If approval instructions for one piece of company value information have been received from two or more evaluators, the processing unit 13 uses one or more evaluator attribute values that are paired with the two or more evaluator identifiers included in the approval instructions, to judge whether or not the approval condition is satisfied. For example, the processing unit 13 calculates an overall score, using the evaluator scores that are respectively paired with the two or more evaluator identifiers included in the approval instruction, and judges that the approval condition is satisfied if the overall score is no less than or greater than a threshold value. Note that the overall score is, for example, the sum of two or more evaluator scores, the maximum value of two or more evaluator scores, the value of two or more evaluator scores, the minimum value of two or more evaluator scores, or the like.

If approval instructions for one piece of company value information have been received from two or more evaluators, the processing unit 13 determines that the approval condition is satisfied if the number of approval instructions is no less than or greater than a threshold value.

(Step S323) The processing unit 13 accumulates the approval flag in pair with the company identifier included in the approval instruction received in step S321.

(Step S324) The credit processing unit 134 performs credit security processing. Processing returns to step S301. The credit security processing is performed to, for example, encrypt and transmit the approval flag accumulated by the processing unit 13 and company credit information that includes the company value information paired with the approval flag, and so on, to one or more other information processing devices.

(Step S325) The processing unit 13 transmits an error message to the terminal device 2. Processing returns to step S301.

Note that, in the flowchart shown in FIG. 3, the credit processing unit 134 may perform the same processing as step S318 after step S320.

In the flowchart shown in FIG. 3, processing is terminated when power is turned off or an interruption is made to terminate the processing.

Next, an example of the stock number determination processing in step S304 will be described with reference to the flowchart shown in FIG. 4.

(Step S401) The stock number determination unit 135 acquires the company identifier included in the payment instruction received in step S301.

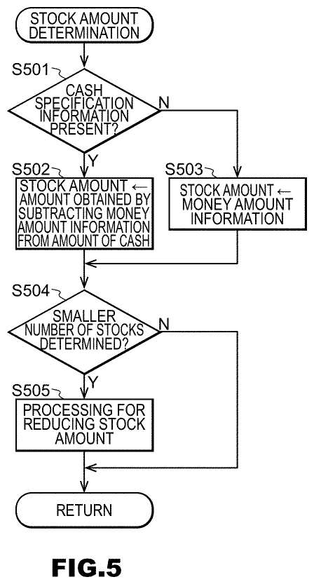

(Step S402) The stock number determination unit 135 determines the amount of money that is to by paid with stocks. An example of such stock amount determination processing will be described with reference to the flowchart shown in FIG. 5.

(Step S403) The stock number determination unit 135 acquires a stock price. Note that, for example, the stock number determination unit 135 reads out the stock price paired with the company identifier acquired in step S401, from the company storage unit 112. Alternatively, the stock number determination unit 135 reads out the company value information, debt value information, and stock number information paired with the company identifier acquired in step S401, from the company storage unit 112, substitutes the read out company value information, debt value information and stock number information into the arithmetic expression “stock price=(company value information−debt value information)/stock number information” stored in the storage unit 11, and executes the arithmetic expression to acquire the stock price.

(Step S404) The stock number determination unit 135 calculates the number of stocks through the arithmetic expression “stock amount/stock price”, using the amount of money (stock amount) to be paid with stocks, acquired in step S402, and the stock price acquired in step S403. Processing returns to higher-level processing.

Next, an example of the stock amount determination processing in step S402 will be described with reference to the flowchart shown in FIG. 5.

(Step S501) The stock number determination unit 135 judges whether or not cash specification information is present. If cash specification information is present, processing proceeds to step S502, and if cash specification information is not present, processing proceeds to step S503. Note that the case in which cash specification information is present is, for example, a case in which cash specification information is included in the received payment instruction, a case in which the cash specification information is stored in the company storage unit 112 in pair with the company identifier, a case in which common cash specification information is stored in the storage unit 11, or the like.

(Step S502) The stock number determination unit 135 substitutes “an amount obtained by subtracting money amount information from the amount of cash” for the variable representing the stock amount that is the amount of money to be paid with stocks. Processing proceeds to step S504.

(Step S503) The stock number determination unit 135 substitutes “money amount information” for the variable representing the stock amount that is the amount of money to be paid with stocks.

(Step S504) The stock number determination unit 135 judges whether or not an amount of money smaller than the amount of money corresponding to the stocks is to be allocated to the payment with stocks. In the case of a smaller number of stocks, processing proceeds to step S505, and if the number of stocks worth equal to the amount of money corresponding to the stocks, processing returns to higher-level processing.

(Step S505) The stock number determination unit 135 performs processing to reduce the value of the variable “stock amount” calculated in step S502 or step S503. Processing returns to higher-level processing. Note that the stock number determination unit 135 reduces the value of the variable “stock amount” according to a predetermined rule (for example, “reduce n yen”, or “m %”) to acquire a new value of the variable “stock amount”. For example, the stock number determination unit 135 calculates a new value of the variable “stock amount” through “stock amount=stock amount−n yen” or “stock amount=stock amount×(m/100)”. The predetermined rule may be associated with the company identifier, or shared amount all of the companies and stored in the storage unit 11.

Next, an example of the guarantee score acquisition processing in step S313 will be described with reference to the flowchart shown in FIG. 6.

(Step S601) The score acquisition unit 133 acquires the evaluator identifier corresponding to the received company value information.

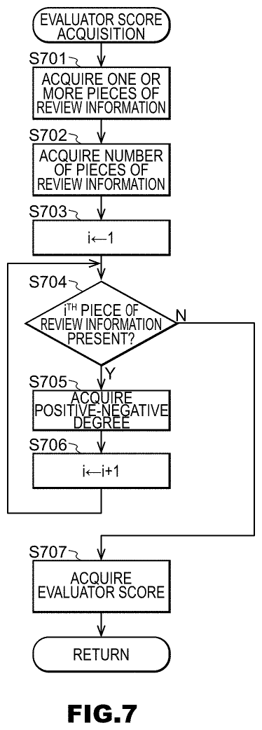

(Step S602) The score acquisition unit 133 performs evaluator score acquisition processing. An example of evaluator score acquisition processing will be described with reference to the flowchart shown in FIG. 7.

(Step S603) The score acquisition unit 133 acquires one or more evaluator attribute values that are paired with the evaluator identifier acquired in step S601, from the evaluator storage unit 111. It is preferable that the one or more evaluator attribute values include the evaluator score acquired in step S602.

(Step S604) The score acquisition unit 133 acquires one or more company attribute values that are paired with the company value information, from the company storage unit 112.

(Step S605) The score acquisition unit 133 acquires a guarantee score, using the one or more attribute values acquired in step S603 and the one or more company attribute values acquired in step S604. Processing returns to higher-level processing.

Note that, in the flowchart in FIG. 6, the score acquisition unit 133 may acquire a guarantee score without using the one or more company attribute values. In such a case, step S604 is unnecessary.

Next, an example of the evaluator score acquisition processing in step S602 will be described with reference to the flowchart shown in FIG. 7.

(Step S701) The score acquisition unit 133 searches for a server device 3, using the evaluator identifier as a key, and receives one or more pieces of review information that are paired with the evaluator identifier, from the server device 3.

(Step S702) The score acquisition unit 133 acquires the number of pieces of review information acquired in step S701.

(Step S703) The score acquisition unit 133 substitutes 1 for the counter i.

(Step S704) The score acquisition unit 133 judges whether or not the i^{th} piece of review information is present. If the i^{th} piece of review information is present, processing proceeds to step S705, and if the i^{th} piece of review information is not present, processing proceeds to step S707.

(Step S705) The score acquisition unit 133 performs natural language processing on the i^{th} piece of review information to acquire a positive-negative degree. Note that the process of acquiring the positive-negative degree of review information is a well-known technique, and therefore the description thereof is omitted here. The positive-negative degree is the degree of positivity or the degree of negativity.

(Step S706) The score acquisition unit 133 increments the counter i by 1. Processing returns to step S704.

(Step S707) The score acquisition unit 133 acquires an evaluator score, using the positive-negative degree acquired in step S705 and the number of pieces of review information. Processing returns to higher level processing. Note that the score acquisition unit 133 acquires a higher evaluator score for a higher degree of positivity and a larger number of pieces of review information. The details of the processing through which the score acquisition unit 133 acquires a score have been described above, and therefore the detailed description thereof is omitted here.

Note that, in the flowchart in FIG. 7, if the evaluator score is stored in the evaluator storage unit 111 in pair with the evaluator identifier, the score acquisition unit 133 may read the evaluator score from the evaluator storage unit 111 in pair with the acquired evaluator identifier.

Next, an example of the approval flag acquisition processing in step S314 will be described with reference to the flowchart shown in FIG. 8.

(Step S801) The flag acquisition unit 132 acquires the evaluator identifier corresponding to the received company value information.

(Step S802) The flag acquisition unit 132 acquires one or more evaluator attribute values that are paired with the evaluator identifier acquired in step S801, from the evaluator storage unit 111.

(Step S803) The flag acquisition unit 132 judges whether or not the one or more evaluator attribute values acquired in step S802 satisfies the approval condition. If the approval condition is satisfied, processing proceeds to step S804, and if the approval condition is not satisfied, processing proceeds to step S805.

(Step S804) The flag acquisition unit 132 acquires an approval flag (for example, “1”).

(Step S805) The flag acquisition unit 132 determines not to acquire an approval flag. Note that the flag acquisition unit 132 may acquire an approval flag (for example, “0”) indicating that approval is not given.

Next, operations of the terminal device 2 will be described. The terminal acceptance unit 22 of the terminal device 2 accepts various kinds of instructions, information, and so on. Next, the terminal processing unit 23 converts the various kinds of instructions and information accepted by the terminal acceptance unit 22 into various kinds of instructions and information in a data structure that is to be transmitted. Next, the terminal transmitting unit 24 transmits the information formed by the terminal processing unit 23 to the information processing device 1. Thereafter, in response to the transmission of the formed information, the terminal receiving unit 25 receives various kinds of information from the information processing device 1. Next, the terminal processing unit 23 converts the information received by the terminal receiving unit 25 into information in a data structure that is to be output. The terminal output unit 26 outputs the information formed by the terminal processing unit 23.

Hereinafter, specific operations of the information system A according to the present embodiment will be described. The conceptual diagram of the information system A is shown in FIG. 1.

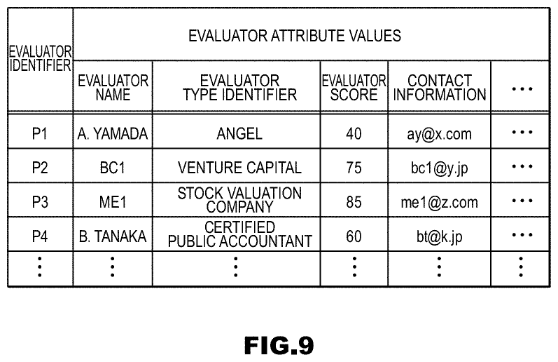

Now, the evaluator storage unit 111 of the information processing device 1 stores the evaluator information management table shown in FIG. 9. The evaluator information management table stores one or more records each including an “evaluator identifier” and “evaluator attribute values”. The “evaluator attribute values” include an “evaluator name”, an “evaluator type identifier”, an “evaluator score”, and “contact information”. Note that “contact information” here is an e-mail address, but may be a telephone number, and address, or the like.

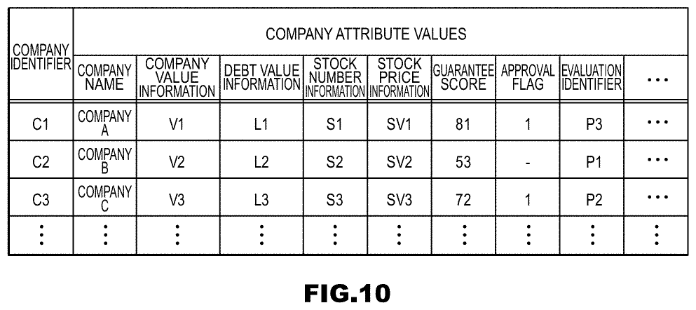

The company storage unit 112 stores the company information management table shown in FIG. 10. The company information management table stores one or more records each including a “company identifier” and “company attribute values”. The “company attribute values” include a “company name”, “company value information”, “debt value information”, “stock number information”, “stock price information”, “guarantee score”, an “approval flag”, and an “evaluator identifier.

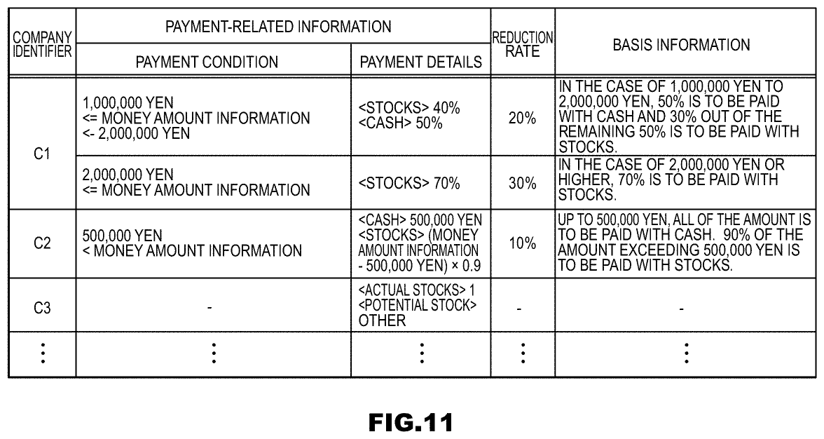

Furthermore, the basis storage unit 113 stores the basis information management table shown in FIG. 11. The basis information table stores one or more records each including a “company identifier”, “payment-related information”, a “reduction rate”, and “basis information”. “Payment-related information” includes a “payment condition” and “payment details”. “Payment-related information” is information regarding a payment method through which stocks and/or cash is used. The “payment condition” is a condition for determine the “payment details”. The “payment details” is information that specifies a payment method through which stocks and/or cash is used. The “reduction rate” is information that specifies the degree of reduction from the actual value when there is payment with stocks. “Reduction rate−20%” means that if the amount of money to be paid is 100, 20 is reduced from 100 and the value corresponding to 80 will be paid with stocks.

In such a situation, it is assumed that an evaluator U has input, to the terminal device 2, a payment instruction to charge a company identified by a company identifier “C1” 1,000,000 yen. As a result, the terminal acceptance unit 22 accepts such a payment instruction. Also, the terminal processing unit 23 forms a payment instruction to be transmitted, namely “<money amount information> 1,000,000 yen, <company identifier> C1”. Next, the terminal transmitting unit 24 transmits the payment instruction “<money amount information> 1,000,000 yen, <company identifier> C1” to the information processing device 1.

Next, the acceptance unit 12 of the information processing device 1 receives the payment instruction “<money amount information> 1,000,000 yen, <company identifier> C1” from the terminal device 2.

Next, the stock number determination unit 135 acquires the money amount information “1,000,000 yen” and the company identifier “C1” from the received payment instruction.

Next, using the company identifier “C1” and the money amount information “1,000,000 yen”, the stock number determination unit 135 references the basis information management table in FIG. 11, and judges that the condition indicated by the company identifier “C1” and the payment condition “1,000,000 yen<=money amount information<2,000,000 yen” is satisfied. That is to say, the stock number determination unit 135 judges that the first condition, which is a condition for using stocks for payment, is satisfied.

Next, the stock number determination unit 135 performs stock number determination processing as follows. That is to say, the stock number determination unit 135 acquires the payment details “<stocks> 40%, <cash> 50%” paired with the company identifier “C1” and the payment condition “1,000,000 yen<=money amount information<2,000,000 yen”. Next, using the cash specification information “<cash> 50%” and the money amount information “1,000,000 yen”, the stock number determination unit 135 calculates “1,000,000 yen×50%” to acquire the cash to be paid, “500,000 yen”. Next, using “<stocks> 40%” and the money amount information “1,000,000 yen”, the stock number determination unit 135 calculates “1,000,000 yen×40%” to acquire the stock amount to be paid with stocks, “400,000 yen”.

Next, the stock number determination unit 135 acquires stock price information “SV1” that is paired with the company identifier “C1” from the company information management table in FIG. 10. Note that the stock price information “SV1” is calculated by the stock number determination unit 135 reading out prestored “company value information (V1)”, “debt value information (L1)”, and “stock number information (S1)” from the table in FIG. 10, and substituting the values thus read out into the arithmetic expression “stock price=(company value information−debt value information)/stock number information”.

Next, the stock number determination unit 135 substitutes the stock amount “400,000 yen” and the stock price information “SV1”” into the arithmetic expression “stock amount/stock price information” stored in the storage unit 11, and executes the arithmetic expression to calculate the number of stocks to be paid (PS).

Next, based on the cash to be paid “500,000” and the number of stocks to be paid (PS), the payment acquisition unit 136 forms, for example, “<type identifier> stocks <stock number information> PS stocks, <type identifier> cash <money amount> 500,000 yen”.

Next, the payment output unit 141 transmits the acquired payment information “<type identifier> stocks <stock number information> PS stocks, <type identifier> cash <money amount> 500,000 yen” to the terminal device 2 of the evaluator U. Also, the payment output unit 141 performs payment assistance processing, using the payment information.

Next, the basis acquisition unit 137 acquires basis information “in the case of 1,000,000 yen to 2,000,000 yen . . . ” that is paired with the company identifier “C1” and the payment condition “1,000,000 yen<=money amount information<2,000,000 yen”, from the basis information management table (FIG. 11).

Next, the basis output unit 142 transmits the acquired basis information “in the case of 1,000,000 yen to 2,000,000 yen . . . ” to the terminal device 2 of the evaluator U.

Next, the terminal receiving unit 25 of the terminal device 2 of the evaluator U receives the payment information “<type identifier> stocks <stock number information> PS stocks, <type identifier> cash <money amount> 500,000 yen” and the basis information “in the case of 1,000,000 yen to 2,000,000 yen . . . ” from the information processing device 1. Next, the terminal processing unit 23 converts the information received by the terminal receiving unit 25 into information in a data structure that is to be output. The terminal output unit 26 outputs the payment information and the basis information formed by the terminal processing unit 23 to the display.

As described above, according to the present embodiment, it is possible to perform appropriate processing for payment with stocks in payment transactions.

Also, according to the present embodiment, it is possible to perform appropriate processing for payment with cash and stocks in payment transactions.

Also, according to the present embodiment, it is possible to perform appropriate processing for payment with one or more types of stocks, of actual stocks and potential stocks, in payment transactions.

Also, according to the present embodiment, it is possible to perform appropriate processing for payment with stocks by calculating the number of stocks to be used for payment to be smaller than the actual amount of money corresponding to the stocks in payment transactions.

Also, according to the present embodiment, when the number of stocks to be used for payment is calculated to be smaller than the actual amount of money corresponding to the stocks, it is possible to provide assistance in convincing the counterparty, by outputting basis information.

Also, according to the present embodiment, it is possible to manage the fact that company value information has been approved, using an approval flag.

Also, according to the present embodiment, it is possible to automatically acquire an approval flag according to an evaluator that has input company value information.

Also, according to the present embodiment, it is possible to prevent tampering with company value information or an approval flag and realize appropriate management.

Also, according to the present embodiment, it is possible to give an appropriate score (guarantee score) based on company value information.

Also, according to the present embodiment, it is possible to give an appropriate score acquired using an evaluator score.

Also, according to the present embodiment, it is possible to acquire an appropriate evaluator score, using review information regarding the evaluator.

Furthermore, according to the present embodiment, it is possible to assist flexible payment with stocks by judging whether or not a predetermined condition is satisfied, and determining the number of stocks corresponding to the payment only when the condition is satisfied.

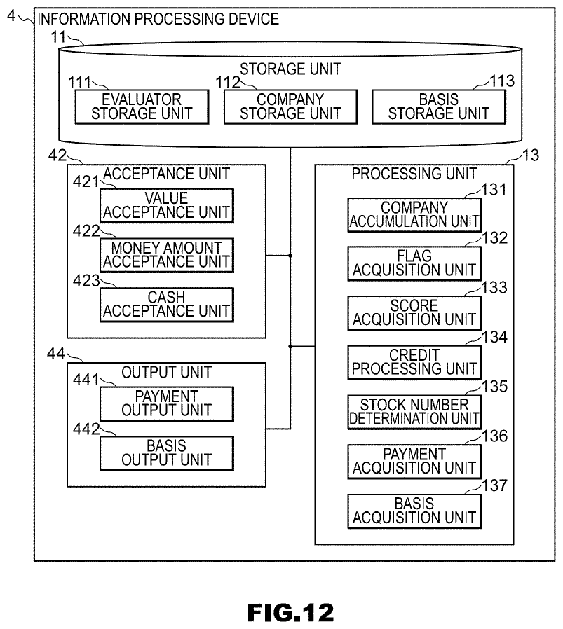

Note that, in the present embodiment, the information processing device 1 may be a stand-alone device. A block diagram for an information processing device 1 in such a case is the block diagram for an information processing device 4 shown in FIG. 12.

In FIG. 12, the information processing device 4 includes a storage unit 11, an acceptance unit 42, a processing unit 13, and an output unit 44. The acceptance unit 42 includes a value acceptance unit 421, a money amount acceptance unit 422, and a cash acceptance unit 423. The output unit 44 includes a payment output unit 441 and a basis output unit 442.

The acceptance unit 42 accepts various kinds of instructions, information, and so on. Examples of various instructions, information, and so on include company value information, an evaluator identifier, money amount information, which will be described later, estimation information, which will be described later, billing information, which will be described later, cash specification information, which will be described later, a payment instruction, review information, an evaluator score, an approval instruction, and an approval flag.

The value acceptance unit 421 accepts company value information. The value acceptance unit 421 typically accepts company value information in association with a company identifier. The money amount acceptance unit 422 accepts estimation information or billing information. The cash reception unit 423 accepts cash specification information.

Here, “acceptance” typically is a concept that includes acceptance of information input from an input device such as a keyboard, a mouse, or a touch panel, and acceptance of information read out from a recording medium such as an optical disk, a magnetic disk, or a semiconductor memory.

The output unit 44 outputs various kinds of information. Examples of various kinds of information include payment information and basis information. The payment output unit 441 outputs the payment information acquired by the payment acquisition unit 136. The basis output unit 442 outputs the basis information acquired by the basis acquisition unit 137.

Here, “output” typically is a concept that includes displaying on a display device, projection with a projector, printing with a printer, sound output, accumulation on a recording medium, delivery of processing results to another processing device or another program, and so on.

In addition, in the above embodiment, descriptions have been given on the premise that there is only one type of stocks. However, companies may issue multiple types of stocks, such as common stocks and preferred stocks, and in such a case, the stock price varies depending on the type of the stock. Therefore, the stock price varies depending on the type of the stocks to be given.

Furthermore, the processing in the present embodiment may be realized using software. This software may be distributed through software downloading or the like. Also, this software may be recorded on a recording medium such as a CD-ROM and distributed. Note that the same applies to the other embodiments in the present description. The software that realizes the information processing device 1 and the information processing device 4 in the present embodiment is the program described below. That is to say, this program is a program that enables a computer that can access a company storage unit that stores company information that includes company value information that specifies the value of a company and stock number information that specifies the number of stocks of the company, to function as: a money amount acceptance unit that accepts estimation information that includes money amount information that specifies the amount of money to be billed, or billing information that includes money amount information; a stock number determination unit that determines the number of stocks that is equivalent to all or part of the amount of money specified by the money amount information accepted by the money amount acceptance unit, and that corresponds to payment, using the company value information and the stock number information; a payment acquisition unit that acquires payment information that includes information that specifies the number of stocks determined by the stock number determination unit, and that is information regarding payment for the amount of money specified by the money amount information; and a payment output unit that outputs the payment information.

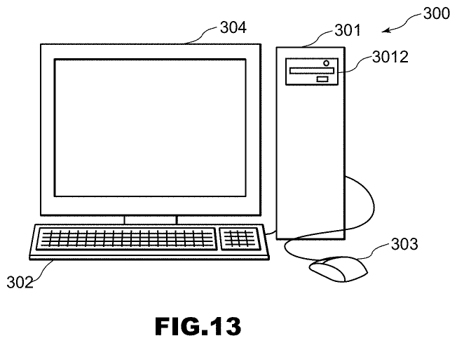

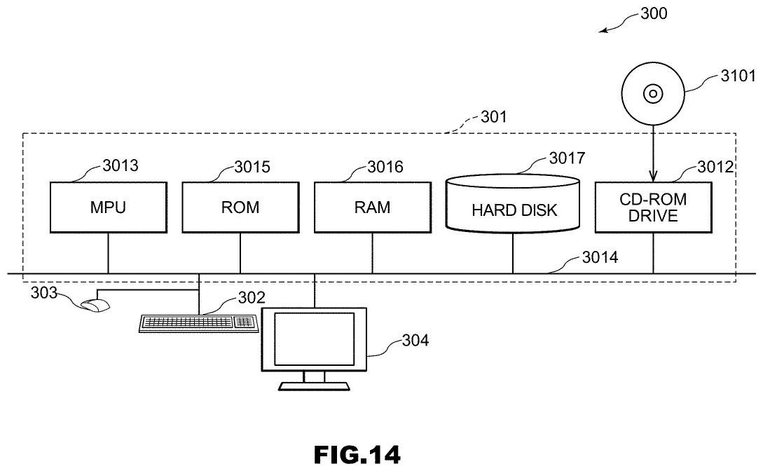

FIG. 13 shows the external appearance of a computer that executes the program described herein to realize the information processing device 1 and so on of the various embodiments described above. The above-described embodiments can be realized using computer hardware and a computer program that runs thereon. FIG. 13 is an overview diagram for this computer system 300 and FIG. 14 is a block diagram for the system 300.

In FIG. 13, the computer system 300 includes a computer 301 that includes a CD-ROM drive, a keyboard 302, a mouse 303, and a monitor 304.

In FIG. 14, the computer 301 includes, in addition to the CD-ROM drive 3012, an MPU 3013, a bus 3014 that is connected to the CD-ROM drive 3012 and so on, a ROM 3015 for storing programs such as a boot-up program, a RAM 3016 that is connected to the MPU 3013 and is used to temporarily store application program instructions and provide a temporary storage space, and a hard disk 3017 for storing application programs, system programs, and data. Here, although not shown in the drawings, the computer 301 may further include a network card that provides connection to a LAN.

The program that enables the computer system 300 to perform the functions of the information processing device 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the information processing device 1 and so on according to the embodiment described above. The program need only contain the part of the instruction that calls an appropriate function (module) in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single or multiple computers executing the above-described program. That is to say, centralized processing or distributed processing may be performed.

Also, as a matter of course, in each of the above-described embodiments, two or more communication means (the terminal information transmitting unit, the terminal information receiving unit, and so on) that are present in one device may be physically realized using one medium.

Also, in the above-described embodiments, each kind of processing (each function) may be realized as centralized processing that performed by a single device (system), or distributed processing performed by multiple devices.

As a matter of course, the present invention is not limited to the above-described embodiments, and various changes are possible, and such variations are also included within the scope of the present invention.

### Industrial Applicability

As described above, an information processing device according to the present invention has the effect of realizing appropriate processing for payment with stocks in payment transactions, and is effective as a transaction processing device or the like.

1. An information processing device comprising:
a company storage unit that stores company information that includes company value information that specifies a value of a company and stock number information that specifies the number of stocks of the company, or stock price information that specifies a stock price;
a money amount acceptance unit that accepts money amount information that specifies an amount of money to be billed;
a stock number determination unit that determines the number of stocks that is equivalent to all or part of the amount of money specified by the money amount information accepted by the money amount acceptance unit, and that corresponds to payment, using the company value information and the stock number information, or the stock price information;
a payment acquisition unit that acquires payment information that includes information that specifies the number of stocks determined by the stock number determination unit, and that is information regarding payment for the amount of money specified by the money amount information; and
a payment output unit that outputs the payment information.

2. The information processing device according to claim 1, further comprising:
a cash acceptance unit that accepts cash specification information that specifies cash to be used for payment,
wherein the payment acquisition unit uses information that specifies the number of stocks determined by the number of stocks determination unit and the cash specification information, to acquire the payment information.

3. The information processing device according to claim 1,
wherein the stock number determination unit determines the number of stocks of one type or two types, of the number of actual stocks and the number of potential stocks.

4. The information processing device according to claim 1,
wherein the stock number determination unit determines the number of stocks equivalent to a smaller amount of money than the amount of money specified by the money amount information accepted by the money amount acceptance unit.

5. The information processing device according to claim 4, further comprising:
a basis acquisition unit that acquires basis information regarding a basis of the determination when the stock number determination unit determines the number of stocks equivalent to the smaller amount of money; and
a basis output unit that outputs the basis information.

6. The information processing device according to claim 1, further comprising:
a value acceptance unit that accepts company value information or stock price information;
a flag acquisition unit that acquires an approval flag that approves acceptance of the company value information or the stock price information; and
a company accumulation unit that accumulates company information that includes the company value information or the stock price information, and the approval flag, in the company storage unit.

7. The information processing device according to claim 6,
wherein the value acceptance unit further accepts an evaluator identifier, and
the flag acquisition unit acquires an approval flag when the evaluator identifier accepted by the value acceptance unit satisfies a predetermined condition.

8. The information processing device according to claim 6, further comprising:
a credit processing unit that, in response to the acquisition of company value information, the stock price information, or the approval flag, performs credit security processing to manage company credit information that includes at least one of the company value information, the stock price information, and the approval flag, in one or more other information processing devices, using a smart contract according to a blockchain technology.

9. The information processing device according to claim 1, further comprising:
an evaluator storage unit that stores one or more pieces of evaluator information that each include an evaluator identifier and one or more evaluator attribute values;
a value acceptance unit that accepts an evaluator identifier, and company value information or stock price information;
a score acquisition unit that acquires guarantee score that indicates a degree of guarantee of the company value information or the stock price information, using one or more evaluator attribute values paired with the evaluator identifier; and
a company accumulation unit that accumulates the guarantee score in the company storage unit in association with the company value information or the stock price information.

10. The information processing device according to claim 9,
wherein the one or more evaluator attribute values include an evaluator score that specifies a rating of an evaluator.

11. The information processing device according to claim 10,
wherein the evaluator score is a score acquired using one or more pieces of review information that is information regarding a comment given to the evaluator, and is information associated with the evaluator identifier.

12. The information processing device according to claim 1,
wherein the stock number determination unit judges whether or not a predetermined condition is satisfied, and determines the number of stocks corresponding to payment, only when the condition is satisfied, and
when the stock number determination unit does not determine the number of stocks, the payment acquisition unit acquires payment information that does not include information that specifies the number of stocks.

13. An information processing method that is realized using a company storage unit that stores company information that includes company value information that specifies a value of a company and stock number information that specifies the number of stocks of the company, or stock price information that specifies a stock price, a money amount acceptance unit, a stock number determination unit, a payment acquisition unit, and a payment output unit, the information processing method comprising:
a money amount acceptance step in which the money amount acceptance unit accepts estimation information that includes money amount information that specifies the amount of money to be billed, or billing information that includes money amount information;
a stock number determination step in which the stock number determination unit determines the number of stocks that is equivalent to all or part of the amount of money specified by the money amount information accepted in the money amount acceptance step, and that corresponds to payment, using the company value information and the stock number information, or the stock price information;
a payment acquisition step in which the payment acquisition unit acquires payment information that includes information that specifies the number of stocks determined by the stock number determination unit, and that is information regarding payment for the amount of money specified by the money amount information; and
a payment output step in which the payment output unit outputs the payment information.

14. A recording medium having recorded thereon a program that enables a computer that can access a company storage unit that stores company information that includes company value information that specifies the value of a company and stock number information that specifies the number of stocks of the company, or stock price information that specifies a stock price, to function as:
a money amount acceptance unit that accepts estimation information that includes money amount information that specifies the amount of money to be billed, or billing information that includes money amount information;
a stock number determination unit that determines the number of stocks that is equivalent to all or part of the amount of money specified by the money amount information accepted by the money amount acceptance unit, and that corresponds to payment, using the company value information and the stock number information, or the stock price information;
a payment acquisition unit that acquires payment information that includes information that specifies the number of stocks determined by the stock number determination unit, and that is information regarding payment for the amount of money specified by the money amount information; and
a payment output unit that outputs the payment information.
